(19) United States
(12) Patent Application Publication
(10) Pub. No.: US 2023/0300395 A1
(43) Pub. Date: Sep. 21, 2023

(54) AGGREGATING MEDIA CONTENT USING A SERVER-BASED SYSTEM

(71) Applicant: OPENTV, INC., San Francisco, CA (US)

(72) Inventors: Sami Karoui, Phoenix, AZ (US); Guy Moreillon, Cheseaux (CH); Diego Castronuovo, Cheseaux (CH)

(73) Assignee: OPENTV, INC., San Francisco, CA (US)

(21) Appl. No.: 18/009,041

(22) PCT Filed: Jun. 11, 2021
(86) PCT No.: PCT/US2021/037049

§ 371 Date: Dec. 8, 2022

Related U.S. Application Data
(60) Provisional application No. 63/038,610, filed on Jun. 12, 2020.

(51) Int. Cl. H04N 21/258; G06F 16/735; H04N 21/431; G06F 16/74

(52) U.S. Cl. CPC H04N 21/25891; G06F 16/735; G06F 16/743; H04N 21/4316

(57) ABSTRACT

Systems and techniques are described herein for processing media content. For example, an item of media content and a content identifier associated with the item of media content can be obtained. Based on the content identifier, a customization profile, a first media platform, and a second media platform associated with the item of media content can be determined. The customization profile can be provided to the first media platform and to the second media platform.

### CROSS-REFERENCE TO RELATED APPLICATIONS

This application claims the benefit of U.S. Pat. Application No. 63/038,610, filed Jun. 12, 2020, which is incorporated herein by reference in its entirety and for all purposes.

### FIELD

This application is related to aggregating media content (e.g., using a server-based system). In some examples, aspects of the present disclosure are related to cross-platform content-driven user experiences. In some examples, aspects of the present disclosure are related to aggregating media content based on tagging moments of interest in media content.

### BACKGROUND

Content management systems can provide user interfaces for end user devices. The user interfaces allow users to access the content provided by the content management systems. Content management systems may include, for example, digital media streaming services (e.g., for video media, audio media, text media, games, or a combination of media) that provide end users with media content over a network.

Different types of content provider systems have been developed to provide content to client devices through various mediums. For instance, content can be distributed to client devices (also referred to as user devices) using telecommunications, multichannel television, broadcast television platforms, among other applicable content platforms and applicable communications channels. Advances in networking and computing technologies have allowed for delivery of content over alternative mediums (e.g., the Internet). For example, advances in network and computing technologies have led to the creation of over-the-top media service providers that provide streaming content directly to consumers. Such over-the-top media service providers provision content directly to consumers over the Internet.

Much of the currently available media content can be engaged with only through a flat, two-dimensional experience, such as a video that has a certain resolution (height and width) and multiple image frames. However, media content includes content in addition to that which such a two-dimensional experience offers. For example, video includes objects, locations, people, songs, and other content that is not directly referenced through a layer that users can interact with.

### SUMMARY

Systems and techniques are described herein for providing cross-platform content-driven user experiences. In one illustrative example, a method of processing media content is provided. The method includes: obtaining a content identifier associated with an item of media content; based on the content identifier, determining a customization profile, a first media platform, and a second media platform associated with the item of media content; providing the customization profile to the first media platform; and providing the customization profile to the second media platform.

In another example, an apparatus for processing media content is provided that includes a memory configured to store media data and a processor (e.g., implemented in circuitry) coupled to the memory. In some examples, more than one processor can be coupled to the memory and can be used to perform one or more of the operations. The processor is configured to: obtain a content identifier associated with an item of media content; based on the content identifier, determine a customization profile, a first media platform, and a second media platform associated with the item of media content; provide the customization profile to the first media platform; and provide the customization profile to the second media platform.

In another example, a non-transitory computer-readable medium is provided that has stored thereon instructions that, when executed by one or more processors, cause the one or more processors to: obtain a content identifier associated with an item of media content; based on the content identifier, determine a customization profile, a first media platform, and a second media platform associated with the item of media content; provide the customization profile to the first media platform; and provide the customization profile to the second media platform.

In another illustrative example, an apparatus for processing media content is provided. The apparatus includes: means for obtaining a content identifier associated with an item of media content; based on the content identifier, means for determining a customization profile, a first media platform, and a second media platform associated with the item of media content; means for providing the customization profile to the first media platform; and means for providing the customization profile to the second media platform.

In some aspects, the first media platform includes a first media streaming platform, and the second media platform includes a second media streaming platform.

In some aspects the customization profile is based on user input associated with the item of media content.

In some aspects the method, apparatuses, and computer-readable media described above include: obtaining user input indicating a portion of interest in the item of media content as the item of media content is presented by one of the first media platform, the second media platform, or a third media platform; and storing an indication of the portion of interest in the item of media content as part of the customization profile.

In some aspects the user input includes selection of a graphical user interface element configured to cause one or more portions of media content to be saved.

In some examples, the user input includes a comment provided in association with the item of media content using a graphical user interface of the first media platform, the second media platform, and/or a third media platform.

In some aspects, the content identifier includes a first channel identifier indicating a first channel of the first media platform associated with the item of media content and a second channel identifier indicating a second channel of the second media platform associated with the item of media content.

In some aspects, the method, apparatuses, and computer-readable media described above include: obtaining first user input indicating a first channel identifier of a first channel of the first media platform, the first user input being provided by a user, wherein the first channel identifier is associated with the content identifier; obtaining second user input indicating a second channel identifier of a second channel of the second media platform, the second user input being provided by the user, wherein the second channel identifier is associated with the content identifier; receiving the first channel identifier from the first media platform indicating the item of media content is associated with the first channel of the first media platform; determining, using the first channel identifier, that the item of media content is associated with the user; and determining, based on the item of media content being associated with the user and based on the second channel identifier, that the item of media content is associated with the second channel of the second media platform.

In some aspects, determining, based on the content identifier, the first media platform and the second media platform includes: obtaining a first identifier of the first media platform associated with the content identifier; determining the first media platform using the first identifier; obtaining a second identifier of the second media platform associated with the content identifier; and determining the second media platform using the second identifier.

In some aspects, the method, apparatuses, and computer-readable media described above include: determining information associated with the item of media content presented on the first media platform; and determining, based on the information, that the item of media content is presented on the second media platform.

In some aspects, the information associated with the item of media content includes at least one of a channel of the first media platform on which the item of media content item is presented, a title of the item of media content, a duration of the item of media content, pixel data of one or more frames of the item of media content, and audio data of the item of media content.

In one illustrative example, a method of processing media content is provided. The method includes: obtaining user input indicating a portion of interest in an item of media content as the item of media content is presented by a first media platform; determining a size of a time bar associated with at least one of a first media player associated with the first media platform and a second media player associated with a second media platform; determining a position of the portion of interest relative to a reference time of the item of media content; and determining, based on the position of the portion of interest and the size of the time bar, a point in the time bar to display a graphical element indicative of moment of interest.

In another example, an apparatus for processing media content is provided that includes a memory configured to store media data and a processor (e.g., implemented in circuitry) coupled to the memory. In some examples, more than one processor can be coupled to the memory and can be used to perform one or more of the operations. The processor is configured to: obtain user input indicating a portion of interest in an item of media content as the item of media content is presented by a first media platform; determine a size of a time bar associated with at least one of a first media player associated with the first media platform and a second media player associated with a second media platform; determine a position of the portion of interest relative to a reference time of the item of media content; and determine, based on the position of the portion of interest and the size of the time bar, a point in the time bar to display a graphical element indicative of moment of interest.

In another example, a non-transitory computer-readable medium is provided that has stored thereon instructions that, when executed by one or more processors, cause the one or more processors to: obtain user input indicating a portion of interest in an item of media content as the item of media content is presented by a first media platform; determine a size of a time bar associated with at least one of a first media player associated with the first media platform and a second media player associated with a second media platform; determine a position of the portion of interest relative to a reference time of the item of media content; and determine, based on the position of the portion of interest and the size of the time bar, a point in the time bar to display a graphical element indicative of moment of interest.

In another illustrative example, an apparatus for processing media content is provided. The apparatus includes: means for obtaining user input indicating a portion of interest in an item of media content as the item of media content is presented by a first media platform; means for determining a size of a time bar associated with at least one of a first media player associated with the first media platform and a second media player associated with a second media platform; means for determining a position of the portion of interest relative to a reference time of the item of media content; and means for determining, based on the position of the portion of interest and the size of the time bar, a point in the time bar to display a graphical element indicative of moment of interest.

In some aspects, the user input includes selection of a graphical user interface element configured to cause one or more portions of media content to be saved.

In some aspects, the user input includes a comment provided in association with the item of media content using a graphical user interface of the first media platform, the second media platform, or a third media platform.

In some aspects the method, apparatuses, and computer-readable media described above include: storing an indication of the portion of interest in the item of media content as part of a customization profile for the item of media content.

In some aspects, the reference time of the item of media content is a beginning time of the item of media content.

In some aspects the method, apparatuses, and computer-readable media described above include: displaying the graphical element indicative of moment of interest relative to the point in the time bar.

In some aspects the method, apparatuses, and computer-readable media described above include: transmitting an indication of the point in the time bar to at least one of the first media player and the second media player.

In some aspects, the apparatuses described above can be a computing device, such as a server computer, a mobile device, a set-top box, a personal computer, a laptop computer, a television, a virtual reality (VR) device, an augmented reality (AR) device, a mixed reality (MR) device, a wearable device, and/or other device. In some aspects, the apparatus further includes a display for displaying one or more images, notifications, and/or other displayable data.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative embodiments of the present application are described in detail below with reference to the following figures:

FIG. 1 is a diagram illustrating an example of a user interface, in accordance with some examples;

FIG. 2 is a diagram illustrating a user interface including a moment selection button and various moments of interest with an item of media content, in accordance with some examples;

FIG. 3 is a diagram illustrating an example visual illustration of moments on video player, in accordance with some examples;

FIG. 4 is a diagram illustrating an example of parties involved in the cross-platform process and example interactions amongst the various parties, in accordance with some examples;

FIG. 5 is a diagram illustrating an example of a system mapping of a content item to a content owner, content channels, and hosting platforms to determine user experience, in accordance with some examples;

FIG. 6A and FIG. 6B are diagrams illustrating examples of an aggregation-based comparison method to determine whether to aggregate clipped moments, in accordance with some examples;

FIG. 7 is a signal diagram illustrating an example of communications among a browser, a client application, a video platform, and an application server, in accordance with some examples; and

FIG. 8 is a flowchart illustrating an example of a process for processing media content, in accordance with some examples; and

FIG. 9 is a flowchart illustrating another example of a process for processing media content, in accordance with some examples; and

FIG. 10 is a block diagram illustrating an example of a computing system architecture, in accordance with some examples.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the example embodiments will provide those skilled in the art with an enabling description for implementing an example embodiment. It should be understood that various changes may be made in the function and arrangement of elements without departing from the spirit and scope of the application as set forth in the appended claims.

Systems, apparatuses, methods (or processes), and computer-readable media (collectively referred to herein as “systems and techniques”) are provided herein for providing a cross-platform content-driven user experience. In some cases, an application server and/or an application (e.g., downloaded to or otherwise part of a computing device) can perform one or more of the techniques described herein. The application can be referred to herein as a cross-platform application. In some cases, the application server can include one server or multiple servers (e.g., as part of a server farm provided by a cloud service provider). The application server can be in communication with the cross-platform application. The cross-platform application can be installed on a website (e.g., as a browser plug-in), can include a mobile application (e.g., as an application add-in), or can include other media-based software. In some cases, a content owner can set up an account with a cross-platform service provider that provides a cross-platform service via the cross-platform application and associated application server.

Through personal computers and other computing devices (e.g., mobile phones, laptop computers, tablet computers, wearable devices, among others), users are exposed to a vast amount of digital content. For example, as users navigate digital content for work or leisure, they are exposed to pieces of media content that may be worth saving and/or sharing. In some examples, the systems and techniques described herein provide content curation or aggregation. The content curation can allow users to seamlessly identify or discover curated moments (e.g., favorite or best moments) of a given piece of media content and at the same time easily (e.g., by providing a single click of a user interface button, icon, etc. of the cross-platform application or a computing device through which a user views the content) be able to contribute to the curation for others to benefit from. In some examples, using such curation, a longer item of media content can be clipped into one or more moments of interests (e.g., with each moment including a portion or clip of the item of media content). In some cases, in addition to clipping content into moments of interest, the moments of interest can be ranked (e.g., ranked by the number of users who tagged or clicked them, ranked based on the potential likes and/or dislikes provided by other users, etc.). Such an additional layer of curation allows the systems and techniques to have a strong indicator of quality and interest among all the clips.

Different methods of tagging moments of interest in media content are described herein. A first method can provide a seamlessly-available option for users to select a moment selection option or button (e.g., a graphical user interface icon or button, a physical button on an electronic device, and/or other input) to save an extract of a particular piece of content. In some cases, as noted above, a cross-platform application installed on a user’s device (e.g., a browser extension, an application add-in, or other application) can be used to display such an option for selection by a user. In one illustrative example, when watching a YouTube™ video for example, a user can click a moment selection button to save a clip of a moment that is a certain length (e.g., 3-10 seconds), triggering the save of the action before the click time, after the click time, or both before and after the click time, as described herein. The time window for the clip can be pre-determined by the application server based on content category, based on an authorized (e.g., business) account, custom defined by the user, or any combination thereof.

Such a method based on a moment selection button can be leveraged towards other users viewing that same content as a way to curate that content and suggest a moment of interest within an item of media content (e.g., including a portion of the item of media content, which can include a media clip such as a video or a song) for other users to view, replay, share, and/or use in some other way. Such a moment of interest can be referred to herein as a clipped moment. For instance, based on selection of the option to save and/or share an extract of media content and the resulting clipped moments curated by one or more users, the curated clipped moments can be displayed by the cross-platform applications installed on user devices of other users viewing that same content. In some examples, for one or more users viewing a particular video on a media platform (e.g., YouTube™, Facebook™, etc.) that is associated with one or more clipped moments (e.g., corresponding to a moment of interest), the cross-platform application can present a curated set of clipped moments (e.g., corresponding to some or all of the one or more clipped moments) related to that video. In such examples, all viewers of that same content can be presented with the resulting clipped moments. In one illustrative example, a user can provide user input causing a media player on a YouTube™ webpage to open a YouTube™ video. Based on detecting the video, the cross-platform application can automatically display a visual representation of clipped moments corresponding to specific clipped moments in that video (e.g., based on a user-selected moment, automatically selected moments as described below, etc.). The clipped moments can be curated (e.g., clipped) by other users using cross-platform applications installed on their devices or automatically time tagged (e.g., based on text in a comments section of the Youtube™ website using linked timestamps, as described below). When that same piece of content is viewed on another platform, those same clipped moments and experience can be rendered for users to benefit from the curation and content-based user experience.

In some examples, a second method (also referred to as auto-tagging) is provided for identifying the moments of interest (and generating clipped moments for the moments of interest) in an item of media content without requiring a user to click to save a clipped moment for the moment of interest through an application or other interface. In one example, automatically identifying moments of interest in an item of media content can be achieved by retrieving time tags that some users who have watched the content posted (e.g., as a comment, such as a user commenting “watch the action at time instance 5:03”, corresponding to 5 minutes and 3 seconds into the content). Such a solution is able to automatically (e.g., using application programming interface (API) and page content) retrieve those tagged moments (also referred to herein as clipped moments) and transform them into clipped moments that are playable and shareable. For example, a cross-platform application installed on a user device of a user viewing an item of media content (e.g., a YouTube™ video) associated with comments indicating a moment of interest in the item of media content can automatically display those tagged moments as clipped moments (e.g., video clips) that are ready to be replayed and shared. This second method of automatically identifying moments of interest can be used alone or in combination with the user-selection based first method described above. In some cases, if a user used the first method to click and save their own clipped moments using a button or other option provided by a user interface of the cross-platform application, a comparison method (described in more detail below) can be used to compare those clipped moments to some or all existing moments. Some of the clipped moments can be aggregated to avoid having clipped moments with overlapping (e.g., duplication) content.

In some examples, the aggregation or curation methods described above (e.g., crowd sourced clips determined through active selections by users of user interface button and/or automated system driven auto-selections) can be provided as part of a broader cross-platform user experience that is defined and automatically activated based on the content being viewed. For example, a content creator can have a content item published on different platforms (e.g. YouTube™, Facebook™, Twitch™, among others) and can have a custom-defined user experience (e.g., including custom graphical layout, colors, data feeds, camera angles, etc.) activated automatically for users watching that content creator’s content on any of the various platforms. The custom-defined user experience can be defined using a customization profile that can be provided to various platforms for displaying a user interface according to the user experience. For instance, the customization profile can include metadata defining clipped moments, graphical layout, colors, data feeds, camera angles, among other customization attributes. Using the customization profile, the user experience can follow the content rather than being driven by the platform used to view the content. In some cases, in addition to the customization of the user experience, users may also be able to save clipped moments. In some examples, the saved clipped moments can be automatically branded by a brand or sponsor (e.g., using pre-roll, post-roll, watermark(s), overlay(s), advertisement(s), among others). In such cases, when users share clipped moments by posting the clipped moments to one or more content sharing platforms (e.g., social media websites or applications, among others), the clipped moments can include the desired branding defined by the content owner for its own brand or its sponsor(s)′ brands. In some examples, with one or more clipped moments that are shared, the solution can automatically add a link or reference to the original longer piece of content (e.g., a full YouTube™ video when a clipped moment from the full video is shared) to the text posted with the clip (e.g., through a tweet via Twitter™, a message or post via Facebook™, a message, an email, etc.). For instance, such examples can be implemented when technically allowed by social media platforms (e.g., based on a particular social media platform not allowing third parties to append a custom text to the actual text entered by the end user).

As noted above, the systems and techniques can provide content aggregation and/or content promotion. For example, clipped moments within one or more items of media content auto-clipped (using the second method described above) or clipped by different users (using the first method described above) on a given platform (e.g., YouTube™, Facebook™, Instagram™, and/or other platform) can be made visible to other users on the same platform and/or on other platforms where that same content is published (e.g., Facebook™, etc.). As described in more detail below, clipped moments corresponding to a particular item of media content can be aggregated under the umbrella of a unique content identifier (ID) associated with the item of media content. The unique content ID can be mapped to that particular item of media content and to clipped moments that are related to the particular item of media content. As the item of media content is displayed across different platforms, the unique content ID can be used to determined clipped moments to display in association with the displayed item of media content. By facilitating the discovery of short curated clipped moments across platforms and crowd sourcing the curation process, content owners and right holders can enable and enhance the promotion of their content, their brand, and their sponsor. In some examples, a channel (e.g., a YouTube™ channel) upon which content is displayed can be associated with a unique channel ID. The unique channel ID can be used by the cross-platform application server and/or the cross-platform application to determine content to display and a layout of the content for that channel.

As noted above, the systems and techniques can provide a custom (e.g., business specific) experience in some implementations. While there are many different type of content available on the Internet, the experience for watching that content is largely similar regardless of the content category. For example, YouTube™ typically renders the same user experience whether a user is watching a hockey game, a plumbing tutorial, or a political debate. In other words, current solutions do not allow for a fully custom, content-specific, and cross-platform experience to be rendered. An alternative is to build a custom website and embed media content in the custom website, but not all content creators have the resources or agility for such a solution.

In some examples, the customization provided by the systems and techniques described herein can occur at three levels, including customization for the content owner, customization for the content item, and customization for the end user. For example, a content owner can define a certain graphical signature that would overlay on all that content owner’s content. Then, for a content of a certain type, such as content related to soccer, the content owner can define a live game statistics module to display for all users. Further, for the content owner’s content related to motor racing, the content owner can decide to show a module displaying in-car camera streams. With respect to customization at the end-user level, the end user can have the option to toggle on or off certain module(s) or change the layout, size, position, etc. of those module(s) based on the personal preference of the end user. A “module” in such contexts can include a displayable user interface element, such as an overlay, a ticker, a video, a set of still images, and/or other interface element.

Various customization preferences of a user can be saved by an application server in a customization profile of a content owner and in a profile of an end user (for the end user level customization). The preferences can include toggling on/off certain module(s) or add-ons, changing the layout, size, position, etc. of the module(s), and/or other preferences. The preferences stored in a content owner’s customization profile can be relied on when an end user accesses that content item regardless of the video platform (YouTube™, Facebook™, etc.) used by end users to view that content item. By providing content owners and/or rights-holders with a solution that automatically exposes their audience to a user experience that follows their content and that is specific to their business and content, the content owners and/or rights-holders can enhance user engagement, increase promotion, and enable new monetization opportunities through short-form content. In some cases, such a customized user experience can be deployed horizontally through a single software application (e.g., executed by a user device and implemented or managed on the back-end by the application server), such as the cross-platform application described herein, that dynamically renders the user experience based on content, website, application, uniform resource locator (URL), etc., as a user navigates to different websites and webpages via the Internet.

Much of the currently available media content can be engaged with only through a flat, two-dimensional experience, such as a video that has a certain resolution (height and width) and multiple image frames. However, media content carries much more than the content that such surface-level layers render. For example, video includes objects, locations, people, songs, and many other things that are not directly referenced through a layer that users can interact with. In other words, media content is lacking depth.

The systems and techniques described herein can provide such depth to media content by providing “Over-The-Content” layers carrying information and experiences that allow users to interact with items (e.g., objects, locations, people, songs, etc.) included in the media content. One challenge is the referencing of those items in media content. One way to address such an issue is to rely on crowd sourcing to add such layers of references to items in the media content. For example, with a simple user experience that could be rendered over different media players, users can opportunistically contribute to adding references to things such as objects, locations, people, songs, etc., and the cross-platform application and application server can be responsible for storing and retrieving those references for presentation to other users consuming that same content on the same or different media platforms. Such “Over-The-Content” layers would not only enrich the user engagement with content through explorable depth, but can also unlock new “real-estate” for brands and businesses to connect with an audience through a context associated with media content (e.g., through the scene of the video) and through an advertisement-based approach where users are pulling advertisements to them (e.g., a user pauses to explore content in depth) as opposed to advertisements being pushed to users as they are in traditional broadcast or streaming advertising.

The systems and techniques described herein provide a technology solution that would benefit various parties, including content owners and rights holders by enabling them to crowd source curation and promotion of their content through a fully custom user experience dynamically rendered on the user device based on the content being watched. End users can also benefit by such systems and techniques by enabling the end-users to seamlessly discover, save, and share the best moments of a piece of content. The end users can easily contribute to the crowd curation and enrichment process for others to view and explore as they view that same content. Brands and advertisers can also benefit by enabling them to promote their brand or products through crowd curated short-form content, which by design puts in the hands of end users the power to capture, share, and/or directly purchase products and services enabled “Over-The-Content” by the content owner using the cross-platform application. Brands and advertisers benefit by relying on multiple viewers for associating their products and services with portions (clips) from media content items, such as an end-user tagging a hotel room featured in a James Bond movie and adding a link to the booking site for other users to discover, explore, and even book.

In some cases, the cross-platform application and/or the application server can dynamically adjust the functionalities of the cross-platform application and/or can adjust the layout and/or appearance of the user interface (e.g., button image, colors, layout, etc.) of the cross-platform application based on a particular item of media content the user is watching. In some aspects, the cross-platform application can become invisible (e.g., a browser extension is not visible as an option on an Internet browser) when a user causes a browser to navigate to other websites that are not supported by the functionality described herein. The cross-platform application can be used whether the user is anonymous or signed into an account (after registering with the application server). In some cases, certain functionalities of the cross-platform application can be enabled only when a user is registered and/or signed into the service provided by the application server. Such functionalities can include, for example, a cross device experience (described below), the ability to download curated content (described below), and/or other relevant features described herein. In some cases, the core functionality allowing users to discover existing clipped moments, to click to save new clipped moments, and to replay and share clipped moments can be available to anonymous users (not signed in) and to users that are signed in.

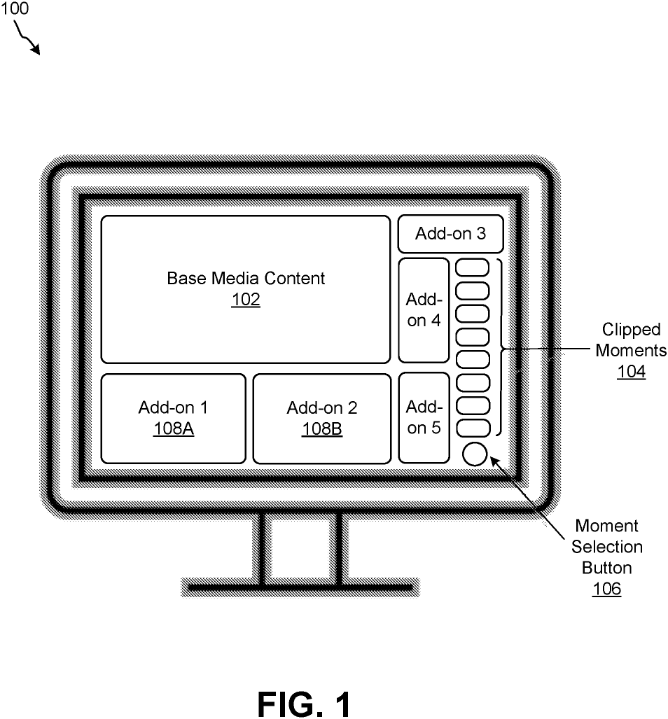

Various examples will now be described for illustrative purposes with respect to the figures. FIG. 1 is a diagram illustrating an example of a user interface generated and displayed by a device 100. In some cases, the user interface is generated by a software application (referred to as a “cross-platform application”) installed on the device 100. For instance, a user can cause the cross-platform application to be installed on the user’s device (e.g., a browser extension installed on the user’s Internet browser), which can implement one or more of the operations described herein. The cross-platform application can be in communication with an application server, as described above. The cross-platform application can include a browser extension (a software application developed for web browsers), an application add-in, or other application, as also described above. A browser extension will be used as an illustrative example, however one of ordinary skill will appreciate that other types of software applications or programs can be used to implement the features described herein. In some examples, the cross-platform application may only appear when the user is on a supported site (e.g., YouTube™), as noted above.

As shown in FIG. 1, the device 100 displays base media content 102 on the user interface of the cross-platform application. In one illustrative example, the base media content 102 can include a video played using a browser extension on a webpage hosted by a particular platform, such as a YouTube™ webpage. While certain media platforms (e.g., the YouTube™ platform, the Facebook™ platform, etc.) are used herein as illustrative examples of platforms for which users view media content, one of ordinary skill will appreciate that any video-based viewing application or program can be used to provide media content for consumption by end-users. Further, while video is used herein as an illustrative example of media content, the techniques and systems described herein can be used for other types of media content, such as audio content consumed via audio streaming platforms, such as Pandora™, Spotify™, Apple Music™, among others.

In some examples, a user experience provided by the cross-platform application can be rendered based on content, channel (e.g., a particular YouTube™ channel of a user), website domain, website URL, any combination thereof, and/or based on other factors. A website domain can refer to the name of the website (www.youtube.com), and one or more URLs can provide an address leading to any one of the pages within the website. In some examples, a content owner can define a customized user experience for content owned by the content owner across various platforms that host media content for the content owner. As noted above, in some cases, a content owner can set up an authorized account (e.g., a business account) with a cross-platform service provider that provides a cross-platform service via the cross-platform application and associated application server. The application server and/or cross-platform application (e.g., installed on a user device) can activate a particular user experience for a content owner’s (with an authorized account) content and for the content owner’s content channels across various platforms hosting media content.

In some examples, when a user provides user input causing a video (e.g., the base media content 102) to be displayed on a page of a particular media platform (e.g., a webpage of a platform hosting a website, such as YouTube™), the cross-platform application can determine or identify the website address (and other metadata where available) and can verify the website address against business rules defined on the application server backend. The business rules can provide a mapping between content, an owner of the content, and a particular user experience for the content. For instance, based on the mapping, a unique content identifier (ID) for media content A can be identified as belonging to owner A, and a business rule can define the user experience (e.g., content such as modules/add-ins, clipped moments or other content, layout of the content, etc.) that will be displayed in association with the media content A for owner A. The business rules can be defined by the content owner, based on a genre of the content (e.g., display a certain user experience for fishing content versus sports content), based on a type of the content (e.g., a basketball game versus a football game), and/or defined based on other factors. Based on the business rules, the cross-platform application and/or application server can determine whether the cross-platform service provided by the cross-platform application and application server is authorized for the domain defined by the website address and whether the open page (e.g., determined using a URL and/or other data available) belongs to a content owner with an authorized account that is active on the platform. As noted above, the application server and/or cross-platform application can activate a user experience for content owned by the content owner (e.g., based on the content owner’s customization profile) and for content channels across various platforms hosting media content. The application server and/or cross-platform application can detect when another user lands on a page displaying the content owned by the content owner, and can render the features and user experience (e.g., one or more add-ons, one or more clipped moments, etc.) defined by that content owner’s customization profile.

For instance, using YouTube™ as an illustrative example of a platform that can be serviced by the cross-platform application server and that provides content belonging to a content owner with an authorized account, the cross-platform application can retrieve a custom skin (including but not limited to button image, colors, layout, etc.) and functionalities (e.g. additional camera angles, live game statistics, betting, etc.) defined by the customization profile of the content owner. The cross-platform application can then render the resulting experience on the user display. The layout and content shown in FIG. 1 is one example of such a user experience. In some examples, the user experience can be displayed as an overlay over a webpage. For instance, an overlay allows the cross-platform application to not have to reload the webpage to render itself. Rather, the overlay can be displayed on top of the existing webpage. In some examples, where appropriate (if allowed by the website or application), the cross-platform application can dynamically modify the webpage layout and/or content to fit the new functionality modules. If the platform is serviceable but there is no business account associated with a channel of the platform or with content that is currently being displayed on the webpage, the cross-platform application can load and render a default skin and functionalities associated with that platform and can also load the functionalities appropriate for the type of content category being watched (e.g., sports, education, etc.).

In some cases, the cross-platform application can cause various add-on functional modules to be dynamically loaded and displayed on the user interface based on one or more factors. In one example, the add-on functional modules can be loaded based on content being viewed (e.g., the base media content 102), website domain, URL, and/or other factors, as noted above. Five example add-on functional modules are shown in FIG. 1, including add-on 108A and add-on 108B. In some examples, the application and/or application server can retrieve add-on functionalities specific to content being displayed and/or based on one or more business rules. For example, depending on the type of content being displayed (e.g., the base media content 102), additional functional and data modules (e.g., add-on 108A, add-on 108B, etc.) can be loaded to provide an experience tailored for that content. Examples of the add-on functional modules can include a statistics feed for a sporting event (e.g., indicating statistics of one or more players involved in the sporting event), different camera angles for a sporting event, a voting feature (e.g., allowing users to vote on certain topics, such as which team will win a sporting event that is being displayed), a tagging feature to add a custom text, voice note, score, etc., any combination thereof, and/or other functionalities. In some cases, the functionalities to load for a given content item, website, webpage URL, etc. can be determined by the category of content (e.g., a sports category, an education category, a politics category, a nature category, etc.), by the content owner, by a possible sponsor attached to the service provided by the application server, any combination thereof, and/or any other factors.

The user interface of FIG. 1 also includes a moment selection button 106. A user can provide a user input to select the moment selection button 106. The user input can include any suitable input, such as a touch input provided using a touchscreen interface, a selection input using a keypad, a selection input using a remote control device, a voice input, a gesture input, any combination thereof, and/or other input. In response to selection of the moment selection button 106 based on the user input, the cross-platform application can save an extract of the particular portion of the base media content 102 (or a previous instance of the base media content 102) that is being displayed at the time the moment selection button 106 was selected by the user based on the user input. The extracts can be referred to herein as clipped moments. Various clipped moments 104 are shown in FIG. 1. The clipped moments 104 can be based on selection of the moment selection button 106 when the base media content 102 is being viewed through the interface of FIG. 1, can be based on selection of a moment selection button during a previous viewing of the base media content 102 by the user or one or more other users, or based on automatically identified moments of interest (as described above). For instance, various users viewing the base media content 102 can suggest one or more moments of interest within the base media content 102 for other users to view, replay, share, etc. Based on selection of the moment selection button 106 and/or automatically-identified moments of interest during the base media content 102, the clipped moments can be displayed on the user interface of other users viewing the same base media content 102.

In some cases, for media content that is currently being displayed (e.g., the base media content 102) on a webpage, one or more clipped moments may have been previously generated for that content, such as based on curation by one or more other users (e.g., based on selection of a moment selection button, such as moment selection button 106) or auto-clipped by the system. In such cases, upon display or during display of the media content, the cross-platform application can retrieve (e.g., from a local storage, from the application server, from a cloud server, etc.) the previously-generated clipped moments and can display the clipped moments (e.g., as clipped moments 104) for viewing by a current user.

In some examples, the application server can assign each item of content that can be displayed (e.g., via one or more webpages, applications, etc.) to a unique identifier (e.g., by a page URL and/or other metadata where available) that uniquely identifies the media content. The application and/or application server can retrieve one or more clipped moments by determining the identifier. For instance, each time a browser, application, or other software application loads a particular webpage URL, the cross-platform application can report the identifier (e.g., the URL) to the cross-platform application server on the backend. The cross-platform application server can check for business rules and objects attached to that identifier and can return the corresponding items (e.g., clipped moments, color codes, logo of the brand, image to be used as the moment selection button for the content owner of the content being displayed, etc.) and data for the cross-platform application to render.

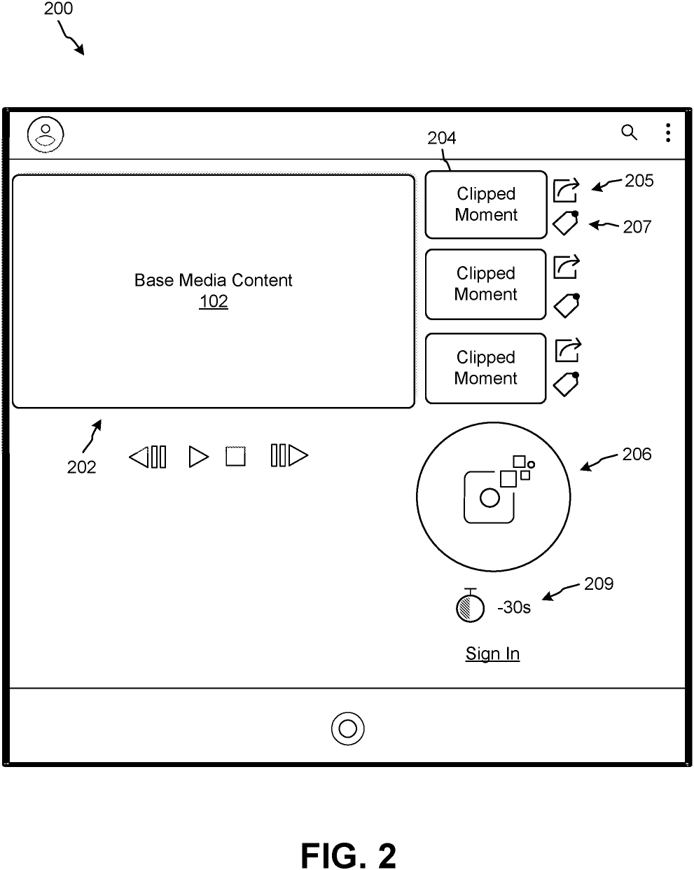

In some implementations, when a user selects the moment selection button 106 while watching a video on a video player of the platform (e.g., a YouTube™ video), the cross-platform application can determine the currently played video time stamp from the video player. In some cases, the cross-platform application can obtain or capture an image shown by the player (e.g., to use as a thumbnail of the moment) at the time (or the approximate time) when the moment selection button 106 is pressed. The cross-platform application can compute a time window corresponding to a moment of interest. In some cases, the duration can be defined relative to the present time in the media content based on input provided by the user (e.g., based on a clip length option, described below) and/or automatically by the application and/or application server based on the type of content, the content owner specifications, a combination thereof, and/or based on other factors. In some examples, as described in more detail below, the cross-platform application can determine the time window based on a clip length option (e.g., clip length option 209 shown in FIG. 2) that defines a time duration of media content to include in a clipped moment before and/or after the time a moment selection button is selected by a user. In some cases, the time window can be computed using the current relative time in the video, plus and/or minus a duration (e.g., defined by the clip length option). In one illustrative example, if a user clicks a button at minute 5:00 of the video, the time window can include minute 5:00 minus 10 seconds (s) and plus 5 s, resulting in a clip starting at 4:50 and ending at 5:05.

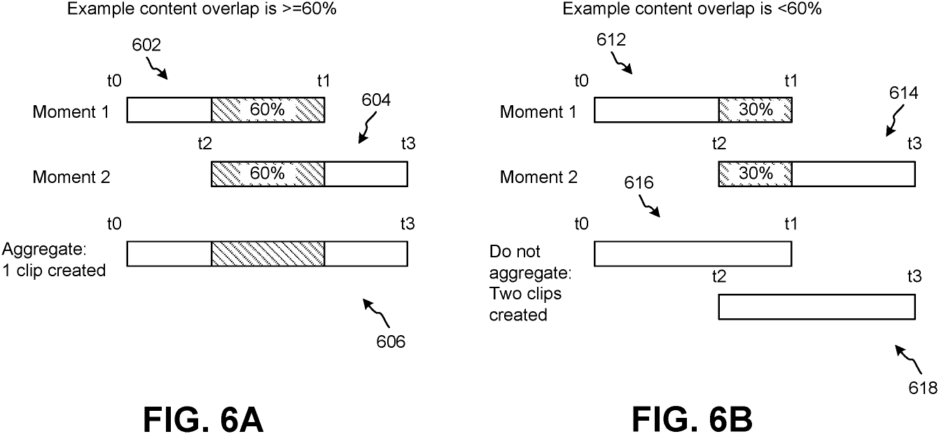

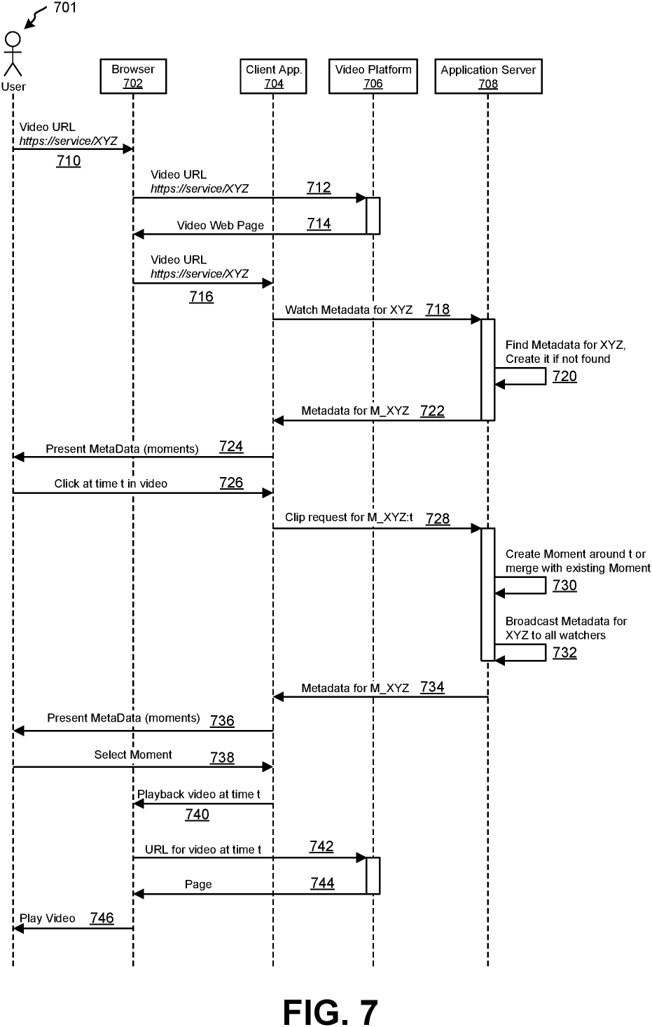

The cross-platform application can send the data (e.g., the video time stamp, the captured image, the time window, any combination thereof, and/or other data) and a clipped moment creation request to the backend application server. As described below, the application server can maintain an object including metadata for certain content, a particular website, a particular domain, a webpage (e.g., identified by a URL), a channel (e.g., identified by a URL) of a given website etc. An example of metadata (or object or event) for content presented on a particular webpage (identified by URL https://service/XYZ, where XYZ is an identifier of the content) is shown in FIG. 7. An illustrative example of an object is a video clip (as an example of a clipped moment) created by a previous user for a video. When a current user clips a moment in the video by selecting a moment selection button 106 to generate a clipped moment, the cross-platform application server and/or application can verify that the clipped moment has not already been clipped/generated by another user by determining if any clipped moments (stored as objects) exist for the portion of the video corresponding to the clipped moment. If the clipped moment has been previously generated by another user, the cross-platform application can cause the user interface (e.g., by scrolling, etc.) to navigate to the corresponding existing clipped moment for the current user, and in some cases can highlight the clipped moment as the resulting clipped moment based on the user’s selection of the moment selection button 106. The backend application server can verify if the website, domain, and/or webpage URL is authorized for the cross-platform service, can verify if there is an existing object (e.g., including metadata) stored for that content, website, or URL, can create an object if it does not have an existing object stored for that content, website, or URL, can apply the corresponding business rules, can verify if an overlapping moment exists already for that event, and/or can run an aggregation algorithm (e.g., as defined with respect to FIG. 6A and FIG. 6B) to determine and return one or more resulting clipped moments for the cross-platform application to display to the user.

In some examples, the cross-platform application and/or application server can automatically generate clipped moments (which can be referred to as auto-clicks) based on time-tagged moments. For instance, if a page includes information about time-tagged moments selected by users or the content owner/creator (e.g., included in the description or comments section with a timestamp linking to a moment in the content, such as a user indicating that “a goal was scored at minute 5:03”), the cross-platform application and/or application server can parse the information and automatically retrieve (e.g., using the API or by reading the page content in the YouTube™ example) those time tags. In one illustrative example, the cross-platform application and/or application server can parse the text within a comment included on a webpage in association with an item of media content by calling a public API of a website to obtain access to the text of the comments, by reading the HyperText Markup Language (HTML) information from the webpage and extracting comments text of the comment, and/or by performing other techniques. The cross-platform application and/or application server can determine when a time tag is included in a given comment based on parsing the text. In some examples, the time tag can be identified based on the format of the time tag (e.g., based on the format of #:##, such as 5:03), based on the type of content (e.g., the tag 5:03 may be interpreted to mean something different when referring to sports content versus cooking show), and/or based on other factors.

The cross-platform application and/or application server can translate the time tags into clipped moments for a given item of media content. For instance, the cross-platform application and/or application server can determine a time window surrounding a time tag (using the techniques described above) corresponding to a time within an item of media content, and can generate a clipped moment that includes that time window. The cross-platform application can render the clipped moments for the item of media content. In some examples, the duration of a clipped moment is not required for the creation a moment. For instance, one timestamp is sufficient to create the moment in some cases. The backend application server can then apply the best business rule based on the type of content, based on requirements and/or preferences defined by the content owner, based on user preferences, or a combination thereof. The curated (clipped) and time tagged moments can be saved as references in the backend application server and can be paired to that content, in which case the application server can automatically provide the clipped moments to the cross-platform application for rendering any time another user starts to view the item of media content.

In some examples, the cross-platform application and/or application server can automatically generate clipped moments based on audio transcripts of media content. For instance, when a user opens a video on the media platform (e.g., a YouTube™ video), the cross-platform application and/or application server can retrieve (if available) or generate the transcripts of the audio of that video and search for keywords. Such list of keywords can be defined based on one or more criteria. Examples of such criteria can include the category of content, the channel, site, and/or domain, a partner brand, and/or custom criteria defined by the content owner or business customer. One word or a combination of keywords can then be used as a trigger to auto-click the moment and create a clipped moment. In some examples, the time window for such an auto-click can differ from the time window when a click is made by users on that same content. In one illustrative example, a user selection of the moment selection button 106 can cause a capture of the past 15 s while the auto-click on that same content can cause a capture of the past 10 s and the next 10 s around the time at which the keyword was detected. In some examples, the time window for such auto-clicks can be defined by the content owner and adjusted by category of content, by a user preference, or a combination thereof.

In some cases, comments and video transcripts or closed-caption information can automatically be transformed into clipped moments that are ready to replay and share. For instance, a content owner on the cross-platform application server can enable an experience for their users, where comments and video transcripts and/or closed-caption information can automatically be transformed into clipped moments. In some examples, the clipped moments can be branded (e.g., edited with a logo, a post-roll, etc.) for the content owner brand or a sponsor of the content owner.

In some implementations, the cross-platform application and/or application server can rank selections made by users (e.g., using moment selection buttons) and/or the auto-clicks generated by the cross-platform application and/or application server. For instance, the ranking can be determined based on the number of users who have time tagged each moment and the rating users may have given to a clipped moment (e.g., by selecting a “like” or “dislike” option or otherwise indicating a like or dislike for the moment). For example, the more users have tagged a moment, the more likely it is to be of strong interest to other users. The same applies for clipped moments which received the most “likes” on a given platform (as indicated by users selecting a “like” icon with respect to the clipped moments). These tags, likes, and/or other indications of popularity can be retrieved from the host platform (e.g., YouTube™, Facebook™, Instagram™, etc.), and in some cases can be combined with tags and likes that have been applied on the clips referenced on the application server platform. In one illustrative example, a formula for ranking clips uses a variable weighting factor multiplying the number of “likes” and another weighting factor multiplying the number of “clicks”. In such an example, the score for a given clip is the sum of the weighted likes and weighted clicks, which can be illustrated as follows:

$$S c o r e = \left(X ∗ n u m b e r o f c l i c k s\right) + \left(Y ∗ n u m b e r o f l i k e s\right) ,$$

where a weight X and a weight Y can be adjusted based on one or more factors, such as the type of clicks (e.g., auto generated or user generated), the platform on which the video and likes have been captured (e.g. YouTube™, Facebook™, etc.), a combination thereof, and/or other factors. While this example is provided for illustrative purposes, one of ordinary skill will appreciate that other techniques for ranking the clips can be performed.

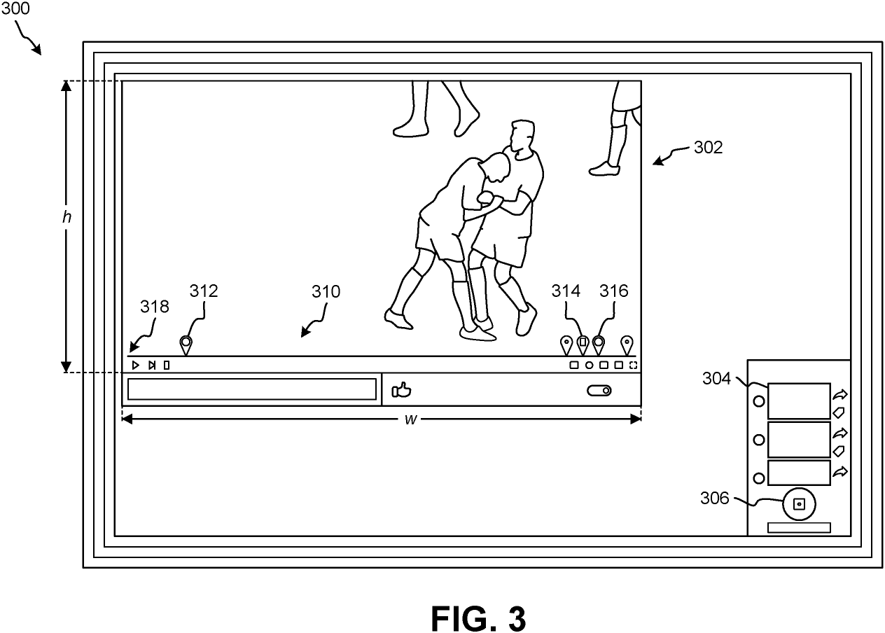

FIG. 2 and FIG. 3 are diagrams illustrating additional examples of user interfaces 200 and 300, respectfully, that include moment selection buttons. For instance, in FIG. 2, a cross-platform application (e.g., a browser extension, mobile application, etc.) causes base media content 202 to be displayed on the user interface 200. The user interface 200 of FIG. 2 includes a moment selection button 206 that can be selected by a user to tag a moment of interest in the base media content 202, which causes a clipped moment (e.g., clipped moment 204) to be generated. In the user interface 300 of FIG. 3, base media content is displayed by a media player 302, along with clipped moments (e.g., clipped moment 304) and moment selection button 306. As noted above, additional clipped moments can be displayed on the user interface 200 of FIG. 2 and/or the user interface 300 of FIG. 3 based on selection of moment selection buttons by one or more other users and/or based on an automatic identification of moments of interest during the base media content.

As shown in FIG. 2, the user interface 200 further includes a clip length option 209. A setting for the clip length option 209 defines a time duration (e.g., x number of seconds) of the base media content 202 to include in a clipped moment before and/or after the time the moment selection button 206 is selected by the user. In the example of FIG. 2, the clip length option 209 is set to -30 seconds (s), indicating that, once the moment selection button 206 is selected, a clip from the base media content 102 is generated that includes a start time beginning 30 seconds prior to selection of the moment selection button 206 and an end time that is a particular duration after selection of the moment selection button 206. In some cases, the end time can include the time duration defined by the clip length option 209 (e.g., 30 seconds after selection of the moment selection button 206), a predetermined or predefined time (e.g., 1 minute after selection of the moment selection button 206), based on when the user releases the moment selection button 206 (e.g., the user can hold down the moment selection button 206 until the user wants the clipped moment to end), and/or based on any other technique.

The user interface 200 of FIG. 2 also includes a share button 205 and a save button 207. The user can provide user input (e.g., a touch input, a keypad input, a remote control input, a voice input, a gesture input, etc.) to select the share button 205. In some cases, based on selection of the share button 205, the cross-platform application can allow the clipped moment 204 to be shared with other users/viewers of the base media content 202. In some cases, based on selection of the share button 205, the cross-platform application can cause the user interface 200 to display one or more messaging options (e.g., email, text message or other messaging technique, social media, etc.) by which the user can send the clipped moment 204 to one or more other users. In one illustrative example, the user can select an email option, in which case the user can cause the cross-platform application to send the clipped moment to another user via email. The user can provide user input selecting the save button 207 and, based on selection of the save button 207, the cross-platform application can cause the clipped moment 204 to be saved to the device upon which the cross-platform application is installed, to a server-based storage, and/or an external storage device.

In some implementations, the cross-platform application and/or application server can generate visual tags of clipped moments. The cross-platform application can render the visual tags of the clipped moments by mapping the visual tags to a user interface of a media player (e.g., over the player time bar). For instance, some or all of the moments tagged by users or auto-tagged (or auto-clicked) by the system can be visually represented relative to a media player time (e.g., a time progress bar of a user interface of the media player) based on the time of occurrence of the moments in the content. Referring to FIG. 3 as an illustrative example, various visual tags are shown relative to a time bar 310 of the user interface 300 of a media player, including a visual tag 312 referencing a goal scored during a soccer match, a visual tag 314 referencing a red card issued during the soccer match, a visual tag 316 referencing an additional goal scored during the soccer match, among others. As shown, each visual tag can include one or more custom graphics based on the type of moment the tag is representing. For instance, the visual tag 312 and the visual tag 316 include a soccer graphic representing a moment related to a soccer goal being scored and the visual tag 314 includes a red card graphic representing a moment related to a red card being given to a player. Other examples can include a particular graphic related to an offside call, among other illustrative examples.

In some examples, the cross-platform application and/or application server can implement a method to map the clipped moments visually on the player time bar using the active dimensions (e.g., width and/or height) of the media player user interface. For instance, referring to FIG. 3 as an illustrative example, the media player 302 of the 300 has a height denoted as h and a width denoted as w. In some examples, the height (h) and the width (w) can be represented as pixels (e.g., a width (w) of 1000 pixels × a height (h) of 700 pixels), as absolute numbers (e.g., a width (w) of 30 centimeters × a height (h) of 20 centimeters), or using any other suitable representation. The application and/or application server can use the dimensions of the media player 302 to determine the size of the time bar and/or the area of the user interface. In one example, the application and/or application server can assume that the length of the time bar is the same as the width (w) of the media player 302. In another example, based on the area, the application and/or application server can determine the location of the time bar, such as at a fixed distance (e.g., in terms of pixels, centimeters, or other measurement) from the bottom to the top of the player user interface. In another example, the application and/or application server can detect (e.g., by performing object detection, such as neural network-based object detection) a time marker at the beginning of the time bar and a time marker at the end of the time bar to determine the length of the time bar. In one example, the time stamp can include a visual time marker (e.g., an icon or other visual indication) on the time bar. In another example, the application and/or application server can detect movement of the time marker over time (e.g., from when the time marker starts to when the time marker stops) to determine the length of the time bar.

Once the player time bar position is determined, the cross-platform application or application server can calculate a relative position of the timestamp for each clipped moment as a percentage from the starting point of the content (corresponding to a beginning point 318 of the time bar 310). The cross-platform application or application server can compare the calculated percentage to the determined width of the player to determine the horizontal position where the visual tag of that moment will be positioned or aligned over the player time bar. For example, referring to FIG. 3, if the cross-platform application or application server determines that the clipped moment identified by the visual tag 312 occurs 10% of the way through the media content item, the cross-platform application or application server can render the visual tag 312 at the point on the time bar 310 that corresponds to 10% of the entire width of the player user interface 300 or the time bar 310 itself.

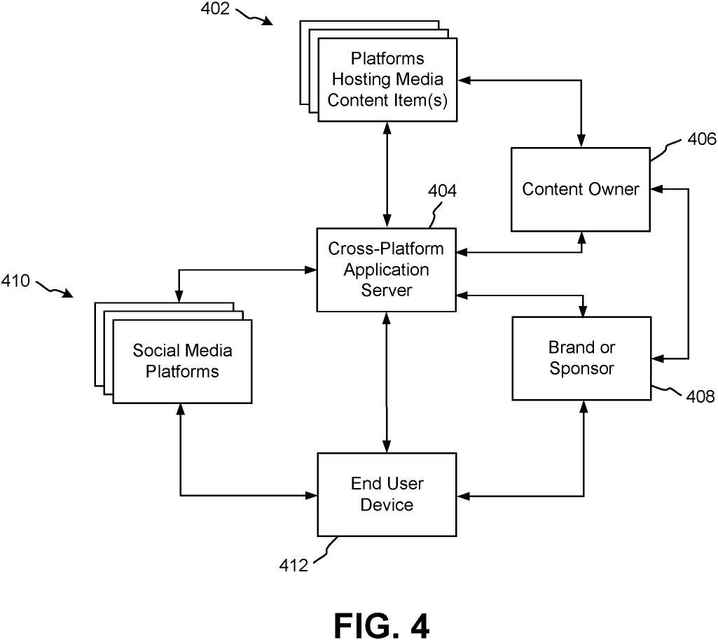

FIG. 4 is a diagram illustrating an example of parties involved in the cross-platform process and example interactions amongst the various parties. As shown, the parties include various platforms 402 hosting one or more media content items, a cross-platform application server 404 (which is in communication with a cross-platform application installed on end user device 412), a content owner 406, a brand/sponsor 408, one or more social media platforms 410, and an end user device 412.

The content owner 406 can upload content to the platforms 402. The content owner can 406 also provide, to the cross-platform application server 404 and/or cross-platform application installed on the end user device 412, an indication of content channels that the content owner 406 owns or uses on the various platforms 402. The content owner 406 can also create a customization profile by providing input to the cross-platform application and/or application server 404 defining user interface skins (e.g., content layout, colors, effects, etc.), add-on module functionalities and configurations, among other user experience customizations. In some cases, the content owner 406 can enter into a sponsorship agreement with the brand or sponsor 408. The brand or sponsor 408 can directly sponsor the application across different content.

The cross-platform application server 404 can interact with the platforms 402, such as by sending or receiving requests for media content to/from one or more of the platforms 402. In some cases, the cross-platform application on the end user device 412 can be a browser plug-in, and the browser plug-in can request content via a web browser in which the plug-in is installed. In some cases, the cross-platform application server 404 can receive the request from the cross-platform application. The cross-platform application server 404 can also retrieve metadata (or objects/events) associated with the media content, as described in more detail herein (e.g., with respect to FIG. 7). The cross-platform application server 404 can provide the metadata to the cross-platform application and/or to the platforms 402. The cross-platform application server 404 can also interact with the social media platforms 410. For example, the cross-platform application server 404 and/or the cross-platform application can upload clipped moments that the end user has allowed to be shared with one or more of the social media platforms 410. The cross-platform application server 404 can also obtain authorization from social media platforms 410 to post on the end user’s behalf.

The end user can interact with the cross-platform application server 404 by providing user input to the cross-platform application via an interface of the end user device 412 (e.g., using gesture based inputs, voice inputs, keypad based inputs, touch based inputs using a touchscreen, etc.). Using the cross-platform application, the end user can watch full media content or clipped moments from items of media content. The end user can also use the cross-platform application to generate clipped moments, share clipped moments, and/or save clipped moments, as described herein. The clipped moments can be displayed to the end-user through a user interface of the cross-platform application with a customized user experience (UX) (e.g., layout, colors, content, etc.) based on the customization profile of the content owner 406. The customized UX and the content can be replicated across the various platforms 402 and social media platforms 410 where the content owner’s content is hosted. The end user can also select a share button (e.g., share button 205 from the user interface 200 of FIG. 2) to share one or more clipped moments via one or more of the social media platforms 410. In some cases, while viewing content sponsored by the brand or sponsor 408, the end user can buy content offered by the brand or sponsor 408.

In some cases, as noted above, the cross-platform application and/or application server can provide cross-platform moment aggregation or mapping. In one illustrative example, an item of media content belonging to a particular content owner can be displayed on a first media platform (e.g., YouTube™). During display of the media content item, the media content item can be clipped to generate one or more clipped moments (e.g., based on selection of one or more moment selection buttons by one or more users or automatically generated). If the content owner publishes the same media content on one or more additional media platforms (e.g., a second media platform supported by the cross-platform service, such as Facebook™) that is/are different from the first media platform, the clipped moments from the initial content displayed on the first platform (e.g., YouTube™) can automatically be shown by the cross-platform application to a user when the user opens that same content on an additional supported platform (e.g., Facebook™). Such cross-platform support can be achieved by using the identifiers (e.g., the URLs) and other page information from the content pages (e.g., content channels) of the first and second platforms (e.g., YouTube™ and Facebook™) on which the content is displayed. For instance, the application and/or application server can obtain a first identifier (e.g., URL) of the first media platform (e.g., for YouTube™) and a second identifier (e.g., URL) for a second media platform (e.g., for Facebook™). The application and/or application can map the first and second identifiers and page information to one unique entity or organization (e.g., an authorized account of a particular content owner) defined on the application server platform. In some cases, the page information can include additional information (e.g., metadata such as keywords) that is included on the source of a webpage but may not be visible on the website. For instance, the page information can be included in the HTML information for a webpage identified by a URL. In general, such information (e.g., metadata) can be used by a search engine to identify websites and/or webpages that are relevant to a user’s search, among other uses. The information can provide additional information for an item of media content, such as keywords associated with a genre of the item of media content (e.g., a sporting event, a cooking show, a fishing show, a news show, etc.), a category or type of the item of media content (e.g., a particular sport such as football or basketball, a particular type of cooking show, etc.), a length of the content, actors, and/or other information. The information can be associated with a unique content ID corresponding to the particular item of content. For instance, the cross-platform application server can associate or map a unique content ID assigned to a particular item of media content A to a content owner, to one or more platforms and/or one or more channels of each platform, to the page information, among other information. In one illustrative example, by identifying information mapped to a unique content ID of media content A, the cross-platform application server can determine that the media content A belongs to content owner A, is available on a first channel of a first platform (e.g., YouTube™) at URL URL X, is available on a first channel of a second platform (e.g., Facebook™) at URL Y, includes a particular type of content (as identified by the page information), includes a particular genre or category (as identified by the page information), etc. The cross-platform application server and/or application installed on a user device can then determine a user experience (e.g., content such as modules/add-ins, clipped moments or other content, layout of the content, etc.) that is associated with the unique content ID for media content A.

In some cases, the mapping noted above can be performed on the fly (e.g., as the information is received) or predefined on the application server platform. For example, the backend application server can obtain or retrieve the identifiers (e.g., the URLs) of the media platforms and other information unique to the channels and content of a content owner from an authorized account of the content owner (e.g., business account). In such cases, when an item of content is identified as belonging to a specific organization (e.g., an authorized account of a particular content owner), the corresponding user experience is loaded and rendered regardless of the platform on which one or more users are watching the content.

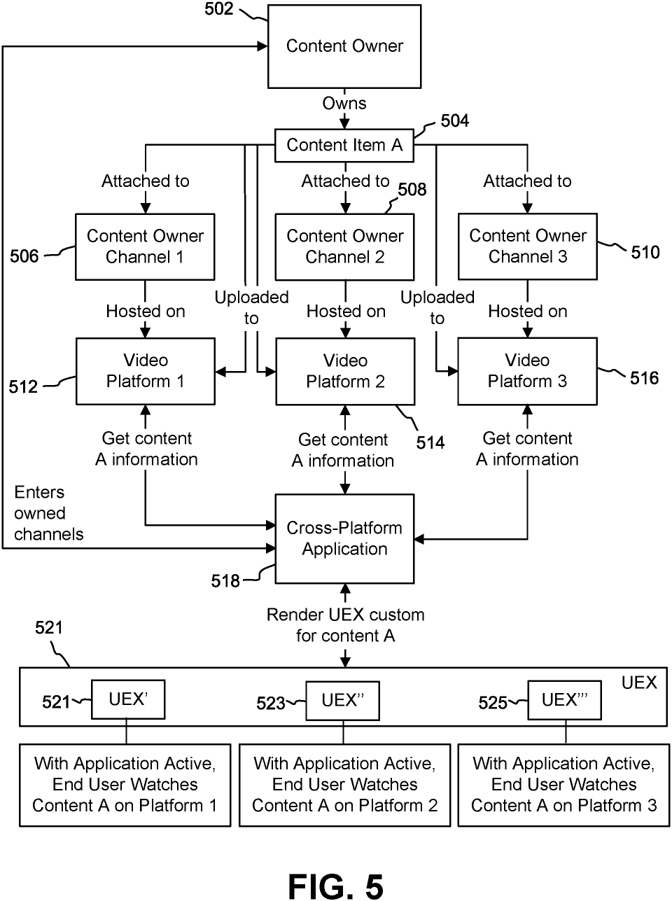

FIG. 5 is a diagram illustrating mapping of a content item to a content owner, content channels, and hosting platforms to determine a particular user experience. As illustrated in FIG. 5, a content owner 502 owns content item A 504. The content item A 504 can include a video in one illustrative example. The content owner 502 can cause the content item A 504 to be uploaded or otherwise added to a first channel (shown as content owner channel 1 506) of a first video platform 512, a second channel (shown as content owner channel 2 508) of a second video platform 514, and a third channel (shown as content owner channel 3 510) of a third video platform 516. In one illustrative example, the first video platform 512 is YouTube™, the second video platform 514 is Facebook™, and the third video platform 516 is Instagram™.

An application 518 is shown in FIG. 5. The application 518 represents the cross-platform application noted above, which is in communication with an application server. The content owner 502 can provide input to a cross-platform application 518 (e.g., using a touchscreen input, keypad input, gesture input, voice input, etc.) indicating that the content owner 502 owns the content owner channel 1 506, the content owner channel 2 508, and the content owner channel 3 510. For instance, the content owner 502 can set up an authorized account (e.g., a business account) with the cross-platform service, as noted above. The content owner 502 can enter a unique identifier (ID) (e.g., URL) associated with the content owner channel 1 506, a unique ID (e.g., URL) associated with the content owner channel 2 508, and a unique ID (e.g., URL) associated with the content owner channel 3 510, as well as unique IDs associated with the corresponding first video platform 512, second video platform 514, and third video platform 516. The user can also enter any customization assets (e.g., user interface elements, images, etc.), can activate one or more modules or add-ons (e.g., the add-on 1 108A from FIG. 1, add-on 2 108B, etc.), can configure a desired user experience (e.g., including certain content, layout of content and/or graphical elements for the user interface, etc.), and/or can perform other functions using the cross-platform application 518.

The cross-platform application server and/or application can use the channel and platform IDs to determine the business rules that map to those IDs. For instance, based on a platform ID associated with a given platform (e.g., YouTube™), the cross-platform application server and/or application can determine the user experience to present on that platform for particular content, as the user experience may be modified for different platforms based on different arrangements of user interface elements on the different platforms (e.g., a YouTube™ webpage displaying an item of media content may look different than a Facebook™ webpage displaying the same item of media content). A channel ID can be used to display a different user experience for the same content displayed on different channels (e.g., channel A can be mapped to a different UX than channel B). The cross-platform application 518 and/or the cross-platform application server can associate or attach the content item A 504 to the content owner channel 1 506, to the content owner channel 2 508, and to the content owner channel 3 510. The cross-platform application 518 and/or the cross-platform application server can obtain information associated with the content item A 504 from the first video platform 512, the second video platform 514, and the third video platform 516. Based on the IDs of the channels and platforms, the cross-platform application 518 can render a user interface with a custom user experience defined by the content owner 502 for the content item A 504 when the content item A 504 is rendered on the first video platform 512, the second video platform 514, and/or the third video platform 516.

In one illustrative example referring to FIG. 5, three users can be viewing the content item A 504 on the first video platform 512, the second video platform 514, and the third video platform 516. The application 518 and/or application server can detect that the content item A 504 is being viewed on the platforms 512, 514, and 516. In response to detecting the content item A 504 is being viewed on the platforms 512, 514, and 516, the application 518 and/or application server can send a request to host servers of the platforms 512, 514, and 516 for an identification of the channels upon which the content item A 504 is being viewed. The application 518 and/or application server can receive a response from a host server of platform 512 indicating that the content item A 504 is being viewed on content owner channel 1 506, a response from a host server of platform 514 indicating that the content item A 504 is being viewed on content owner channel 2 508, and a response from a host server of platform 516 indicating that the content item A 504 is being viewed on content owner channel 3 510. Based on the channel IDs of the channels 506, 508, 510, the application 518 and/or application server can retrieve information associated with the authorized account of the content owner 502 and can determine from the account information one or more business rules (also referred to as a configuration) associated with each of the channels 506, 508, and 510. The application 518 and/or application server can then apply rules from the account information (e.g., defined by the content owner 502) and can render the corresponding user interface with the custom user experience. In some examples, based on the platform IDs of the platforms 512, 514, and 516, the application 518 and/or application server can determine how to present the corresponding user interface with the user experience (e.g., the user experience can be laid out differently based on the platform user interface of each platform 512, 514, 516). In some examples, optional adjustments to the user experience can be applied based on each platform (as shown in FIG. 5 as UEX′, UEX″, and UEX‴). Examples of user experiences (UEX) are shown in FIG. 1, FIG. 2, and FIG. 3.

As described above, the cross-platform application and/or application server can provide a cross-device experience. Such a cross-device experience can be achieved using the concept of an “event” defined on the backend application server. For instance, an event can be identified by an object stored on a database (e.g., maintained on the backend application server or in communication with the backend server) that consolidates interactions of all users around a given item of media content. An object can include metadata, as used in the example of FIG. 7. Unlike other extensions or applications, an object associated with an event allows the cross-platform application and/or application server to render content so that users can see and benefit from what other users do. Each item of content supported by the cross-platform service (via the cross-platform application server and application) is associated with an object or event. One or more users can cause an object to be updated or created for a given event. For instance, each time a user selects an item of content to be added to his/her profile using a particular device (e.g., a laptop or other device), the backend application server can associate that item of content (as an event) and all attached moments to the profile of that user by generating an object (e.g., metadata) for storage on the database. When the user signs in on another device (e.g., a mobile device or other device), the user’s profile and all the user’s corresponding moments (whether clipped by him or others) become available on that device by identifying the stored object (e.g., metadata). As used herein, an item of media content can refer to a full length content item as available from a media platform (e.g., YouTube™), an event is associated with an object stored in the database that aggregates a user’s interactions with that content, and a clipped moment is a subset (e.g., a clip) of the item of media content, whether with content is duplicated or simply time referenced.

In some examples, when a user signs into the cross-platform application (e.g., using a laptop, a desktop computer, a tablet, a mobile phone such as a smartphone, or other computing device), events for which the user generated clipped moments (e.g., based on selection of a moment selection button) or events that were viewed by the user and that the user decided to add to his/her profile can automatically be made accessible on other devices (e.g., laptop, mobile phone, tablets, etc.) running the corresponding version of the cross-platform application for those devices. For instance, from a mobile device, a user can perform multiple actions with respect to an item of media content, such as replay, share, download (when authorized), tag, and/or other actions. A user can also watch the item of media content on a second device with a larger screen or display (e.g., a laptop, desktop, television, etc.). The cross-platform application running on the mobile device can display a moment selection button (e.g., moment selection button 106). While watching the item of media content on the second device with the larger screen, the user can select (by providing user input) the moment selection button displayed by the cross-platform application on the mobile device to save one or more clipped moments. In one illustrative example, a user can be signed into the user’s YouTube™ account and can be watching an item of media content on a YouTube™ webpage from a laptop or desktop device. The user can at the same time use a mobile device to select a moment selection button to save a moment within the media content item. The clipped moment and any other clipped moments can automatically appear in a mobile cross-platform application and also on a cross-platform application running on the laptop or desktop.

In some examples, the application server can download curated content (e.g., clipped moments), such as for branding and other purposes. For instance, when a website, domain, or a channel and/or video of the media platform (e.g., a YouTube™ channel and/or video) belongs to a content owner who has an active authorized account (e.g., a business account) on the platform, clipped moments generated based on user selection of moment selection buttons can be cut out of the actual media file (instead of using time references to the embedded version of the content) at the backend application server, in which case images of the moment may not be captured or grabbed from the screen of the user (e.g., as a screenshot). This approach can, for example, allow clips to be captured by the backend application server in full resolution even when the content (e.g., media stream) played on the user device is downgraded to a lower resolution (e.g., due to Internet bandwidth degradation). In some cases, the media content on the backend application server can be provided either by the content owner (e.g., as a file or as a stream) or accessed directly by the backend application server through the media platform (e.g., from the YouTube™ platform).

In some examples, the cross-platform application and/or application server can generate an activity report for content creators/owners. For instance, when a content owner signs in as an Administrator of a media platform account (e.g., a YouTube™ account) and is active on the Administrator page, the cross-platform application and/or application server can identify the corresponding channel and associated videos and can display relevant activity of one or more users on the user interface. In some cases, this data is only provided when a user is signed in as administrator to the platform in question (e.g., YouTube™).

In some examples, the cross-platform application and/or application server can sort clipped moments based on content/event status. For instance, a list of clipped moments displayed on a user interface of the cross-platform application (e.g., the clipped moments 104 of FIG. 1) can be dynamically sorted based on the status of the content and/or based on an event status. For example, for content showing a live event (e.g., media content being live broadcasted or live streamed), the application and/or application server can display the clipped moments in chronological order, with a most recent clipped moment (most recent in the media content relative to a current time) at the top or beginning of the list. In another example, when content corresponds to an on-demand type of content (e.g., the display of a recorded file), the default display of the moments can be based on a sorting showing the most interesting clipped moments first at the top or beginning of the list. In one illustrative example, the most interesting clipped moments can be based on ranking computation (e.g., based on a variable weighting factor), as described above.

In some cases, users watching an item of media content can, at any item, add a reference to anything appearing in the media content item (e.g., in a video), including but not limited to objects, products, services, locations, songs, people, brands, among others. For example, a user watching a James Bond trailer on YouTube™ could reference a wristwatch the actor is wearing, associating to it text, image(s), link(s), sound(s), and/or others metadata. When such object references are made, the cross-platform application can determine or calculate the location in the video (e.g., location coordinates on the two-dimensional video plane) at which the user pointed when applying the reference (e.g., where the user pointed when referencing the wristwatch). The location coordinates can be measured relative to the player dimension at the time the reference was made, for example with the origin point being one of the corners of the player (e.g., the bottom-left corner). The relative coordinates of the referenced object can then be stored and retrieved to render an overlay of that reference when another user watches that same content item. In some cases, to account for the various dimensions the video player can have, the coordinates can also be calculated in terms of percentage of the video player dimensions when the reference was made. For example, if the video player size is 100×100 and the user referenced an object at position 80×50, the relative percentage expressed in terms of player dimensions at the time of the reference would be 80% and 50%.

In some examples, the application and/or application server can perform a comparison method (e.g., using time-aggregation of clicks) to avoid generation of clips with overlapping action from a given item of media content. For instance, because users on a given media platform (e.g., YouTube™, etc.), can go back in time to replay any part of the content, one or more users can select a moment selection button to save a moment that was previously saved by someone else. Although some or all previously saved moments can be shown to the user, the user may not see that the moment of interest was already clipped and may trigger another clip. In some examples, to avoid having multiple clips including part or all of the same action, each time a user clicks a moment selection button provided by the cross-platform application (e.g., the moment selection button 106 of FIG. 1), the cross-platform application can send a request to the backend application server to verify whether that moment in time exists already as a clipped moment. If the backend application server determines that a clipped moment already exists, the backend application server can return the reference to the previously-generated clipped moment and the cross-platform application can show that clipped moment as the result of the user clipping request.

FIG. 6A and FIG. 6B illustrate examples of a comparison method that is based on an aggregation algorithm. The aggregation algorithm can be implemented by backend application server and/or the cross-platform application. The aggregation algorithm maps two or more overlapping time windows, whether referred to using relative or absolute timestamps, into a single time window that best covers the action of interest for all users that have shown interest (e.g., by selecting a moment selection button) in the moment in the item of media content. As shown in FIG. 6A and FIG. 6B, the aggregation algorithm can be based on a percentage of overlap threshold or rule between two moments. The application server and/or the cross-platform application can determine whether two moments will be combined into a single clipped moment or generated as two separate clipped moments based on whether the percentage of overlap threshold is met. In some examples, the percentage of overlap threshold can vary by category of content, as some time duration (e.g., a number of seconds) missed at the end or beginning of a particular event (e.g., action within a sporting event) may be less of a problem than when missing the end or beginning of another type of event (e.g., a speech, education material, etc.).

FIG. 6A is a diagram illustrating an example of when two moments are aggregated based on the amount of overlap between the two moments being greater than or equal than a percentage of overlap threshold. As shown, a time duration 602 for a first moment within an item of media content is defined by a beginning time t0 and an ending time t1. A time duration 604 for a second moment within the item of media content is defined by a beginning time t2 and an ending time t3. In the example of FIG. 6A, a percentage of overlap threshold of 60% is used. As shown by the grey area within the time duration 602 and the time duration 604, the amount of content overlap between the first moment and the second moment is 60%. Because the amount of overlap (60%) between the first moment and the second moment is equal to the overlap threshold, the application server and/or cross-platform application determine that the first and second moments will be aggregated into an aggregated moment. As shown in FIG. 6A, the aggregated moment includes a combination of the first moment and the second moment, with a duration 606 including a beginning time of t0 and an ending time of t3.

FIG. 6B is a diagram illustrating an example of when two moments are not aggregated based on the amount of overlap between the two moments being less than a percentage of overlap threshold. As shown, a time duration 612 for a first moment within an item of media content is defined by a beginning time t0 and an ending time t1, and a time duration 614 for a second moment within the item of media content is defined by a beginning time t2 and an ending time t3. A percentage of overlap threshold of 60% is used in the example of FIG. 6B. As shown by the grey area within the time duration 612 and the time duration 614, the amount of content overlap between the first moment and the second moment is 30%. The application server and/or cross-platform application determine can determine that the amount of overlap (30%) between the first moment and the second moment is less than the overlap threshold. Based on the amount of overlap being less than the overlap threshold, the application server and/or cross-platform application can determine to generate separate clipped moments for the first moment and the second moment. For example, as shown in FIG. 6B, the application server and/or cross-platform application can generate a first clipped moment having a duration 616 including a beginning time of t0 and an ending time of t1 and a second clipped moment having a duration 618 including a beginning time of t2 and an ending time of t3.

In some examples, one or more content owners and/or right holders streaming an event on a media platform (e.g., YouTube™ or other media platform) can invite members of the viewing audience to install the cross-platform application to activate an enhanced experience. The users can then cause the cross-platform application to generate clipped moments and replay, tag, and/or share their favorite moments. The users can also see in real-time (live) the moments that other users are clipping as the event is happening. The users can also access custom data feeds and additional content (e.g., different camera angles, etc.). As users share clips to social media and/or other media sharing platforms, the content owner can have his/her event, brand, or sponsor promoted with the content branded and/or linked to the original full content.

FIG. 7 is a diagram illustrating an example of communications among a web browser 702, a cross-platform client application 704, a video platform 706, and a cross-platform application server 708. The metadata referenced in FIG. 7 can also be referred to as an “object” or “event,” as previously noted. For example, as described above, an event is a stored object that consolidates interactions of users around a given piece of content. In some cases, the events can be stored on one or more databases or other storage devices, which can be maintained on the backend application server 708 or can be in communication with the application server 708. The client cross-platform application 704 can include a browser extension installed into the browser 702 software, an application add-in, or other application as described herein. The video platform 706 can include any media platform, such as YouTube™, Facebook™, Instagram™, Twitch™, among others.

At operation 710, a user enters a uniform resource locator (URL) corresponding to an item of video content (denoted in FIG. 7 as media content “XYZ”) into an appropriate field of a user interface implemented by the browser 702. At operation 712, the browser 702 accesses the video platform 706 using the URL (e.g., by sending a request to a web server of the video platform 706). At operation 714, the video platform 706 returns to the browser 702 a corresponding webpage that includes the XYZ item of video content. At operation 716, the browser 702 provides the video URL (e.g., which can be used as an ID, as described above) to the cross-platform client application 704.

At operation 718, the client application 704 sends a request to the application server 708 for metadata associated with the XYZ item of media content. At operation 720, the application server 708 searches for metadata (e.g., an object, as noted above) associated with the XYZ item of media content. In some cases, the application server 708 can search for the metadata using the URL as a channel ID to identify a user experience for the XYZ item of media content. For instance, any metadata associated with the XYZ item of media content can be mapped to any URL belonging to a channel that includes the XYZ item of media content. In the event the application server 708 is unable to find metadata associated with the XYZ item of media content, the application server 708 can generate or create such metadata. At operation 722, the application server 708 sends the metadata (denoted in FIG. 7 as M_XYZ) associated with the XYZ item of media content to the client application 704. At operation 724, the cross-platform client application 704 displays clipped moments (e.g., the clipped moments 104 of FIG. 1) and/or other information based on the M_XYZ metadata associated with the XYZ item of media content.

At operation 726, the user 701 provides input to the client application 704 corresponding to selection of a moment selection button displayed on a user interface the client application 704 (e.g., the moment selection button 106 of FIG. 1). The user input is received at time t in the XYZ item of media content. In response, the client application 704 sends a clipped moment request (denoted in FIG. 7 as clip request M_XYZ:t) to the application server 708 at operation 728. At operation 730, the application server 708 creates a clipped moment from the XYZ media content item relative to time t or merges the moment with an existing clipped moment (e.g., using the technique described above with respect to FIG. 6A and FIG. 6B). In some cases, at operation 732, the application server 708 can broadcast or otherwise make available (e.g., by sending directly to each device) the updated metadata (including the new or updated clipped moment) for the XYZ item of media content to all viewers of the XYZ item of media content. At operation 734, the application server sends the updated metadata M_XYZ to the client application 704. At operation 736, the cross-platform client application 704 displays clipped moments (including the new or updated clipped moment from operation 730) and/or other information based on the updated M_XYZ metadata received at operation 734.

At operation 738, the user 701 provides input to the client application 704 corresponding to selection of the clipped moment corresponding to time t in the XYZ item of media content from a user interface the client application 704 (e.g., by selecting one of the clipped moments 104 shown in FIG. 1). At operation 740, the client application 704 sends a request to the browser 702 to play back the selected clipped moment. At operation 742, the browser 702 sends a URL for the XYZ item of media content at time t (or relative to time t, as defined by the clipped moment) to the video platform 706. The video platform 706 returns the webpage corresponding to the URL to the browser 702 at operation 744. At operation 746, the browser 702 plays back the clipped moment relative to time t of the XYZ item of media content.

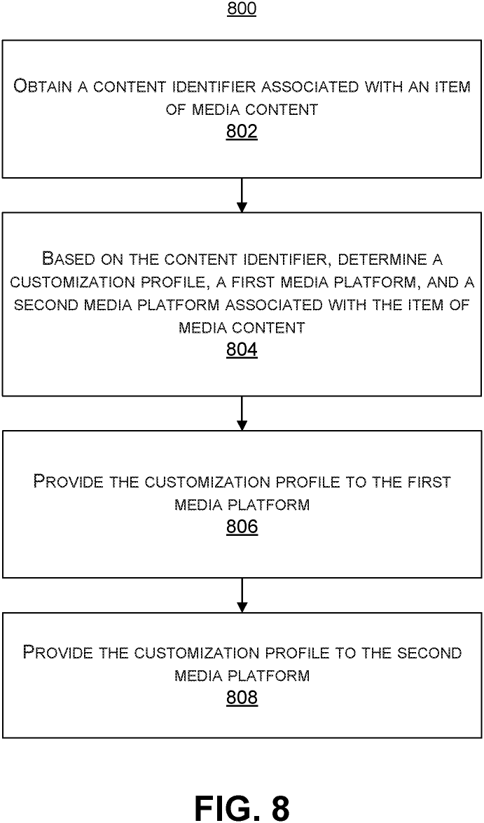

FIG. 8 is a flowchart illustrating an example of a process 800 of processing media content using one or more of the techniques described herein. At block 802, the process 800 includes obtaining a content identifier associated with an item of media content. For example, the cross-platform application server 404 illustrated in FIG. 4 may obtain a content identifier (also referred above to as a unique content ID) associated with an item of media content. In one example, the item of media content can include a video.

At block 804, the process 800 includes determining a customization profile, a first media platform, and a second media platform associated with the item of media content based on the content identifier. For example, the cross-platform application server 404 illustrated in FIG. 4 can determine the customization profile, first media platform, and second media platform based on the content identifier. In some examples, the first media platform includes a first media streaming platform (e.g., YouTube™). In some examples, the second media platform includes a second media streaming platform (e.g., Facebook™). In some examples, the customization profile is based on user input associated with the item of media content. For instance, a content owner of the item of media content can provide user input defining preferences, such as preferences, content to include in a user interface with the item of media content, layout of that content, etc. Examples of preferences can include toggling on/off certain module(s) or add-ons (e.g., the add-ons 108A and 108B in FIG. 1), changing the layout, size, position, etc. of the module(s), and/or other preferences.

In some examples, the process 800 can determine, based on the content identifier, the first media platform and the second media platform at least in part by obtaining a first identifier of the first media platform associated with the content identifier. In some cases, the first identifier of the first media platform can be included in an address (e.g., a URL identifying a location of the item of media content, such as shown in FIG. 7). The process 800 can include determining the first media platform using the first identifier. The process 800 can include obtaining a second identifier (e.g., included in an address, such as a URL identifying a location of the item of media content, such as shown in FIG. 7) of the second media platform associated with the content identifier and determining the second media platform using the second identifier.

At block 806, the process 800 includes providing the customization profile to the first media platform. At block 808, the process 800 includes providing the customization profile to the second media platform. As previously described, the customization profile can be relied upon when an end user accesses the content item associated with the customization profile regardless of the video platform (YouTube™, Facebook™, etc.) used by end users to view that content item.

In some examples, the process 800 can include obtaining user input indicating a portion of interest in the item of media content as the item of media content is presented by one of the first media platform, the second media platform, or a third media platform. In some cases, the user input includes selection of a graphical user interface element (e.g., the moment selection button 106 of FIG. 1) configured to cause one or more portions of media content to be saved. In some cases, such as when performing auto-tagging as described above, the user input includes a comment provided in association with the item of media content using a graphical user interface of the first media platform, the second media platform, or a third media platform. In such examples, the process 800 can include storing an indication of the portion of interest in the item of media content as part of the customization profile.

In some examples, the content identifier includes a first channel identifier indicating a first channel of the first media platform associated with the item of media content (e.g., a YouTube™ channel on which one or more other users can view the item of media content) and a second channel identifier indicating a second channel of the second media platform associated with the item of media content (e.g., a Facebook™ channel on which one or more other users can view the item of media content).

In some examples, the process 800 includes obtaining first user input (provided by a user) indicating a first channel identifier of a first channel of the first media platform. In some case, the first channel identifier is associated with the content identifier. The process 800 can further include obtaining second user input (provided by the user) indicating a second channel identifier of a second channel of the second media platform. In some cases, the second channel identifier is also associated with the content identifier. The process 800 can include receiving the first channel identifier from the first media platform indicating the item of media content is associated with the first channel of the first media platform. The process 800 can include determining, using the first channel identifier, that the item of media content is associated with the user. The process 800 can include determining, based on the item of media content being associated with the user and based on the second channel identifier, that the item of media content is associated with the second channel of the second media platform.

In some examples, the process 800 includes determining information associated with the item of media content presented on the first media platform. In some cases, the information associated with the item of media content includes at least one of a channel of the first media platform on which the item of media content item is presented, a title of the item of media content, a duration of the item of media content, pixel data of one or more frames of the item of media content, audio data of the item of media content, or any combination thereof. The process 800 can further include determining, based on the information, that the item of media content is presented on the second media platform.

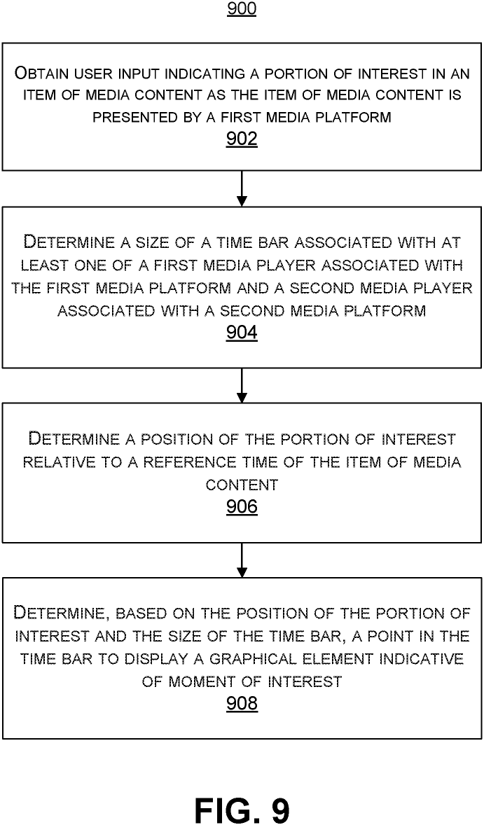

FIG. 9 is a flowchart illustrating an example of a process 900 of processing media content using one or more of the techniques described herein. At block 902, the process 900 includes obtaining user input indicating a portion of interest in an item of media content as the item of media content is presented by a first media platform. For example, the cross-platform application (or the application server in some cases) may obtain user input indicating a portion of interest in an item of media content as the item of media content is presented by a first media platform. In some cases, the user input includes selection of a graphical user interface element configured to cause one or more portions of media content to be saved. In some cases, the user input includes a comment provided in association with the item of media content using a graphical user interface of the first media platform, the second media platform, or a third media platform.

At block 904, the process 900 includes determining a size of a time bar associated with at least one of a first media player associated with the first media platform and a second media player associated with a second media platform. For example, the cross-platform application (or the application server in some cases) may determine the size of the time bar.

At block 906, the process 900 includes determining a position of the portion of interest relative to a reference time of the item of media content. For example, the cross-platform application (or the application server in some cases) may determine the position of the portion of interest relative to the reference time of the item of media content. In some examples, the reference time of the item of media content is a beginning time of the item of media content.

At block 908, the process 900 includes determining, based on the position of the portion of interest and the size of the time bar, a point in the time bar to display a graphical element indicative of moment of interest. For example, the cross-platform application (or the application server in some cases) may determine the point in the time bar to display the graphical element based on the position of the portion of interest and the size of the time bar.

In some examples, the process 900 includes storing an indication of the portion of interest in the item of media content as part of a customization profile for the item of media content. In some examples, the process 900 includes transmitting an indication of the point in the time bar to at least one of the first media player and the second media player.

In some examples, the process 900 includes displaying the graphical element indicative of moment of interest relative to the point in the time bar. For instance, referring to FIG. 3 as an illustrative example, various visual tags are shown relative to a time bar 310 of a user interface 300 of a media player, including a visual tag 312 referencing a goal scored during a soccer match, a visual tag 314 referencing a red card issued during the soccer match, a visual tag 316 referencing an additional goal scored during the soccer match, among others.

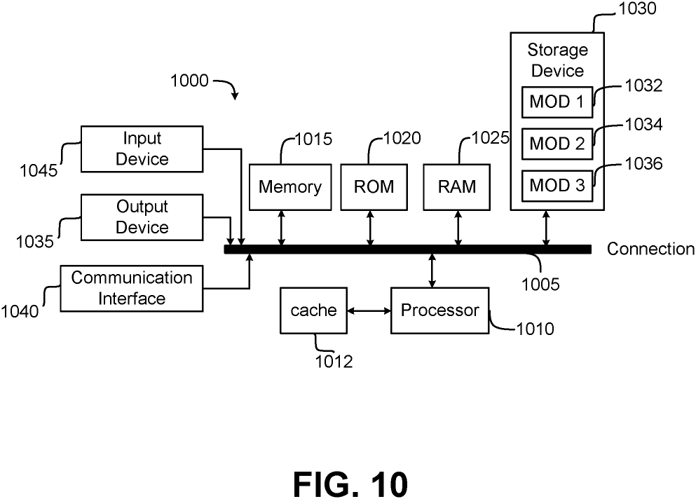

In some examples, the processes described herein may be performed by a computing device or apparatus. In one example, the processes can be performed by the computing system 1000 shown in FIG. 10. In another example, the process 800 can be performed by the cross-platform application server 404 or the cross-platform application described herein. In another example, the process 900 can be performed by the cross-platform application server 404 or the cross-platform application described herein. The computing device can include any suitable device, such as a mobile device (e.g., a mobile phone), a desktop computing device, a tablet computing device, a wearable device (e.g., a VR headset, an AR headset, AR glasses, a network-connected watch or smartwatch, or other wearable device), a server computer, an autonomous vehicle or computing device of an autonomous vehicle, a robotic device, a television, and/or any other computing device with the resource capabilities to perform the processes described herein. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The processes may be described or illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes. For example, although the example processes 800 and 900 depict a particular sequence of operations, the sequences may be altered without departing from the scope of the present disclosure. For example, some of the operations depicted may be performed in parallel or in a different sequence that does not materially affect the function of the processes 800 and/or 900. In other examples, different components of an example device or system that implements the processes 800 and/or 900 may perform functions at substantially the same time or in a specific sequence.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 10 is a diagram illustrating an example of a system for implementing certain aspects of the present technology. In particular, FIG. 10 illustrates an example of computing system 1000, which can be for example any computing device making up internal computing system, a remote computing system, a camera, or any component thereof in which the components of the system are in communication with each other using connection 1005. Connection 1005 can be a physical connection using a bus, or a direct connection into processor 1010, such as in a chipset architecture. Connection 1005 can also be a virtual connection, networked connection, or logical connection.

In some embodiments, computing system 1000 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 1000 includes at least one processing unit (CPU or processor) 1010 and connection 1005 that couples various system components including system memory 1015, such as read-only memory (ROM) 1020 and random access memory (RAM) 1025 to processor 1010. Computing system 1000 can include a cache 1012 of high-speed memory connected directly with, in close proximity to, or integrated as part of processor 1010.

Processor 1010 can include any general purpose processor and a hardware service or software service, such as services 1032, 1034, and 1036 stored in storage device 1030, configured to control processor 1010 as well as a special-purpose processor where software instructions are incorporated into the actual processor design. Processor 1010 may essentially be a completely self-contained computing system, containing multiple cores or processors, a bus, memory controller, cache, etc. A multi-core processor may be symmetric or asymmetric.

To enable user interaction, computing system 1000 includes an input device 1045, which can represent any number of input mechanisms, such as a microphone for speech, a touch-sensitive screen for gesture or graphical input, keyboard, mouse, motion input, speech, etc. Computing system 1000 can also include output device 1035, which can be one or more of a number of output mechanisms. In some instances, multimodal systems can enable a user to provide multiple types of input/output to communicate with computing system 1000. Computing system 1000 can include communications interface 1040, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1040 may also include one or more Global Navigation Satellite System (GNSS) receivers or transceivers that are used to determine a location of the computing system 1000 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1030 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

The storage device 1030 can include software services, servers, services, etc., that when the code that defines such software is executed by the processor 1010, it causes the system to perform a function. In some embodiments, a hardware service that performs a particular function can include the software component stored in a computer-readable medium in connection with the necessary hardware components, such as processor 1010, connection 1005, output device 1035, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative examples of the present disclosure include:

Example 1. A method of processing media content, the method comprising: obtaining a content identifier associated with an item of media content; based on the content identifier, determining a customization profile, a first media platform, and a second media platform associated with the item of media content; providing the customization profile to the first media platform; and providing the customization profile to the second media platform.

Example 2. The method of example 1, wherein the first media platform includes a first media streaming platform, and wherein the second media platform includes a second media streaming platform.

Example 3. The method of any one of examples 1 or 2, wherein the customization profile is based on user input associated with the item of media content.

Example 4. The method of example 3, further comprising: obtaining user input indicating a portion of interest in the item of media content as the item of media content is presented by one of the first media platform, the second media platform, or a third media platform; and storing an indication of the portion of interest in the item of media content as part of the customization profile.

Example 5. The method of example 4, wherein the user input includes selection of a graphical user interface element configured to cause one or more portions of media content to be saved.

Example 6. The method of example 4, wherein the user input includes a comment provided in association with the item of media content using a graphical user interface of the first media platform, the second media platform, or a third media platform.

Example 7. The method of any one of examples 1 to 6, wherein the content identifier includes a first channel identifier indicating a first channel of the first media platform associated with the item of media content and a second channel identifier indicating a second channel of the second media platform associated with the item of media content.

Example 8. The method of any one of examples 1 to 7, further comprising: obtaining first user input indicating a first channel identifier of a first channel of the first media platform, the first user input being provided by a user, wherein the first channel identifier is associated with the content identifier; obtaining second user input indicating a second channel identifier of a second channel of the second media platform, the second user input being provided by the user, wherein the second channel identifier is associated with the content identifier; receiving the first channel identifier from the first media platform indicating the item of media content is associated with the first channel of the first media platform; determining, using the first channel identifier, that the item of media content is associated with the user; and determining, based on the item of media content being associated with the user and based on the second channel identifier, that the item of media content is associated with the second channel of the second media platform.

Example 9. The method of any one of examples 1 to 8, wherein determining, based on the content identifier, the first media platform and the second media platform includes: obtaining a first identifier of the first media platform associated with the content identifier; determining the first media platform using the first identifier; obtaining a second identifier of the second media platform associated with the content identifier; and determining the second media platform using the second identifier.

Example 10. The method of any one of examples 1 to 9, further comprising: determining information associated with the item of media content presented on the first media platform; and determining, based on the information, that the item of media content is presented on the second media platform.

Example 11. The method of example 10, wherein the information associated with the item of media content includes at least one of a channel of the first media platform on which the item of media content item is presented, a title of the item of media content, a duration of the item of media content, pixel data of one or more frames of the item of media content, and audio data of the item of media content.

Example 12. An apparatus comprising a memory configured to store media data and a processor implemented in circuitry and configured to perform operations according to any of examples 1 to 11.

Example 13. The apparatus of example 12, wherein the apparatus is a server computer.

Example 14. The apparatus of example 12, wherein the apparatus is a mobile device.

Example 15. The apparatus of example 12, wherein the apparatus is a set-top box.

Example 16. The apparatus of example 12, wherein the apparatus is a personal computer.

Example 17. A computer-readable storage medium storing instructions that when executed cause one or more processors of a device to perform the methods of any of examples 1 to 11.

Example 18. An apparatus comprising one or more means for performing operations according to any of examples 1 to 11.

Example 19. A method of processing media content, the method comprising: obtaining user input indicating a portion of interest in an item of media content as the item of media content is presented by a first media platform; determining a size of a time bar associated with at least one of a first media player associated with the first media platform and a second media player associated with a second media platform; determining a position of the portion of interest relative to a reference time of the item of media content; and determining, based on the position of the portion of interest and the size of the time bar, a point in the time bar to display a graphical element indicative of moment of interest.

Example 20. The method of example 19, wherein the user input includes selection of a graphical user interface element configured to cause one or more portions of media content to be saved.

Example 21. The method of example 1, wherein the user input includes a comment provided in association with the item of media content using a graphical user interface of the first media platform, the second media platform, or a third media platform.

Example 22. The method of any one of examples 19 to 21, further comprising: storing an indication of the portion of interest in the item of media content as part of a customization profile for the item of media content.

Example 23. The method of any one of examples 19 to 22, wherein the reference time of the item of media content is a beginning time of the item of media content.

Example 24. The method of any one of examples 19 to 23, further comprising: displaying the graphical element indicative of moment of interest relative to the point in the time bar.

Example 25. The method of any one of examples 19 to 23, further comprising: transmitting an indication of the point in the time bar to at least one of the first media player and the second media player.

Example 26. An apparatus comprising a memory configured to store media data and a processor implemented in circuitry and configured to perform operations according to any of examples 19 to 25.

Example 27. The apparatus of example 12, wherein the apparatus is a server computer.

Example 28. The apparatus of example 12, wherein the apparatus is a mobile device.

Example 29. The apparatus of example 12, wherein the apparatus is a set-top box.

Example 30. The apparatus of example 12, wherein the apparatus is a personal computer.

Example 31. A computer-readable storage medium storing instructions that when executed cause one or more processors of a device to perform the methods of any of examples 1 to 11.

Example 32. An apparatus comprising one or more means for performing operations according to any of examples 19 to 25.

What is claimed is:

1. A method of processing media content, the method comprising:
obtaining a content identifier associated with an item of media content;
based on the content identifier, determining a customization profile, a first media platform, and a second media platform associated with the item of media content;
cause content associated with the item of media content to be displayed via the first media platform by providing the customization profile to the first media platform; and
cause the content associated with the item of media content to be displayed via the second media platform by providing the customization profile to the second media platform.

2. The method of claim 1, wherein the first media platform includes a first media streaming platform, and wherein the second media platform includes a second media streaming platform.

3. The method of claim 1, wherein the customization profile is based on user input associated with the item of media content.

4. The method of claim 3, further comprising:
obtaining user input indicating a portion of interest in the item of media content as the item of media content is presented by one of the first media platform, the second media platform, or a third media platform; and
storing an indication of the portion of interest in the item of media content as part of the customization profile.

5. The method of claim 4, wherein the user input includes selection of a graphical user interface element configured to cause one or more portions of media content to be saved.

6. The method of claim 4, wherein the user input includes a comment provided in association with the item of media content using a graphical user interface of the first media platform, the second media platform, or a third media platform.

7. The method of claim 1, wherein the content identifier includes a first channel identifier indicating a first channel of the first media platform associated with the item of media content and a second channel identifier indicating a second channel of the second media platform associated with the item of media content.

8. The method of claim 1, further comprising:
obtaining first user input indicating a first channel identifier of a first channel of the first media platform, the first user input being provided by a user, wherein the first channel identifier is associated with the content identifier;
obtaining second user input indicating a second channel identifier of a second channel of the second media platform, the second user input being provided by the user, wherein the second channel identifier is associated with the content identifier;
receiving the first channel identifier from the first media platform indicating the item of media content is associated with the first channel of the first media platform;
determining, using the first channel identifier, that the item of media content is associated with the user; and
determining, based on the item of media content being associated with the user and based on the second channel identifier, that the item of media content is associated with the second channel of the second media platform.

9. The method of claim 1, wherein determining, based on the content identifier, the first media platform and the second media platform includes:
obtaining a first identifier of the first media platform associated with the content identifier;
determining the first media platform using the first identifier;
obtaining a second identifier of the second media platform associated with the content identifier; and
determining the second media platform using the second identifier.

10. The method of claim 1, further comprising:
determining information associated with the item of media content presented on the first media platform; and
determining, based on the information, that the item of media content is presented on the second media platform.

11. The method of claim 10, wherein the information associated with the item of media content includes at least one of a channel of the first media platform on which the item of media content item is presented, a title of the item of media content, a duration of the item of media content, pixel data of one or more frames of the item of media content, and audio data of the item of media content.

12. An apparatus comprising:
a memory configured to store media data; and
a processor implemented in circuitry and configured to:
obtain an item of media content;
obtain a content identifier associated with the item of media content;
based on the content identifier, determine a customization profile, a first media
platform, and a second media platform associated with the item of media content;
cause content associated with the item of media content to be displayed via the first media platform by providing the customization profile to the first media platform; and
cause the content associated with the item of media content to be displayed via the second media platform by providing the customization profile to the second media platform.

13. The apparatus of claim 12, wherein the first media platform includes a first media streaming platform, and wherein the second media platform includes a second media streaming platform.

14. The apparatus of claim 12, wherein the customization profile is based on user input associated with the item of media content.

15. The apparatus of claim 14, wherein the processor is configured to:
obtain user input indicating a portion of interest in the item of media content as the item of media content is presented by one of the first media platform, the second media platform, or a third media platform; and
store an indication of the portion of interest in the item of media content as part of the customization profile.

16. The apparatus of claim 15, wherein the user input includes selection of a graphical user interface element configured to cause one or more portions of media content to be saved.

17. The apparatus of claim 12, wherein the content identifier includes a first channel identifier indicating a first channel of the first media platform associated with the item of media content and a second channel identifier indicating a second channel of the second media platform associated with the item of media content.

18. The apparatus of claim 12, wherein the processor is configured to:
obtain first user input indicating a first channel identifier associated with a first channel of the first media platform, the first user input being provided by a user, wherein the first channel identifier is associated with the content identifier;
obtain second user input indicating a second channel identifier associated with a second channel of the second media platform, the second user input being provided by the user, wherein the second channel identifier is associated with the content identifier;
receive the first channel identifier from the first media platform indicating the item of media content is associated with the first channel of the first media platform;
determine, using the first channel identifier, that the item of media content is associated with the user; and
determine, based on the item of media content being associated with the user and based on the second channel identifier, that the item of media content is associated with the second channel of the second media platform.

19. The apparatus of claim 12, wherein, to determine the first media platform and the second media platform based on the content identifier, the processor is configured to:
obtain a first identifier of the first media platform associated with the content identifier;
determine the first media platform using the first identifier;
obtain a second identifier of the second media platform associated with the content identifier; and
determine the second media platform using the second identifier.

20. The apparatus of claim 12, wherein the processor is configured to:
determine information associated with the item of media content presented on the first media platform; and
determine, based on the information, that the item of media content is presented on the second media platform.
